(19) United States
(12) Patent Application Publication
(10) Pub. No.: US 2005/0102348 A1
(43) Pub. Date: May 12, 2005

(54) Integrated web based email system and document storage manager

(76) Inventors: Robert R. Parsons, Scottsdale, AZ (US); David Koopman, Scottsdale, AZ (US); Warren Adelman, Scottsdale, AZ (US)

Correspondence Address: Stewart J. Womack;Suite 219, 14455 N. Hayden Road, Scottsdale, AZ, 85260, US

(21) Appl. No.: 10/703,245

(22) Filed: Nov. 7, 2003

(51) Int. Cl. G06F 15/16

(52) U.S. Cl. 709/201

(57) ABSTRACT

The invention integrates the functions of a Web based email system and a document storage manager on a Web site by including a Web site storage area used to store files that may then be accessed by both functions. In one embodiment, a user on a client may access a Web site and transmit emails with attached files via a Web based email system where the attached files were organized and managed by a document storage manager. In another embodiment, the user on a client may access and manage files via a document storage manager where the files were received as attachments to emails by a Web based email system.

### FIELD OF THE INVENTION

The present invention relates to a Web site that integrates the functions of a Web based email system and a document storage manager by sharing access to files, wherein the Web site is accessible from a plurality of clients via a global computer network.

### BACKGROUND OF THE INVENTION

The Internet is a worldwide network of computers and computer networks arranged to allow the easy and robust exchange of information between the users of the computers, i.e. clients. Hundreds of millions of people around the world have access to at least one client connected to the Internet via one of the hundreds of Internet Service Providers (ISPs). Content providers place information, generally multimedia information in the form of graphics, sounds and data, at specific locations on the Internet referred to as Web sites that are typically hosted by an ISP. The combination of all the Web sites and their corresponding Web pages on the Internet is collectively known as the World Wide Web (Web or www).

Users of the Internet routinely send electronic messages, commonly known as emails, to each other over the Internet via email systems. Most internet users find emails to be much more convenient than traditional mail. Traditional mail requires stamps and envelops to be purchased and a supply maintained, while emails do not require the costs and burden of maintaining a supply of associated products. Emails may also be sent with the click of a few buttons, while letters typically need to be transported to a physical location, such as a mail box, before being sent.

Emails may include one or more attached files. The files may be, for examples, documents used for word processing, executable files used to run programs, or one of the many other types of known computer files. Emails are a very popular form of communication over the Internet due to the variety of data that may be transmitted, large number of available recipients, speed, low cost and convenience.

Email delivery systems may be categorized into one of two groups. The first group is non-Web based email systems. The non-Web based email systems automatically forward emails to a particular client associated with the addressee of the email. Recipients may receive their emails simply by turning on their client, connecting their client to the Internet and using a software package, such as Microsoft Outlook produced by Microsoft, to view their email. The user may then save any files attached to the email in the client's storage area, e.g. their computer's hard drive or other storage media, or forward the email, with or without the attachment, to other clients.

A problem exists for this category of email systems in that the user may only access their emails and attached files from a single client. The user may forward attached files to other clients after they have been received, but the user is still initially forced to receive emails from one particular client. In addition, even after forwarding the email to other clients, the user is still restricted to accessing the email from only those clients that received the forwarded email. Users that use a variety of different clients may have trouble accessing their emails with this class of email delivery system from all the clients that they might possibly want to use.

The second group of email delivery systems is Web based email systems. Web based email systems may be included as part of a Web site that allows users to log onto the Web site to receive and transmit their emails. The log in process authenticates the user, typically by asking for a password that only the user knows, to make sure the user should be given access to the emails and their attached files. The advantage of Web based email systems is that users may access their emails and attached files from any client with an Internet connection. This advantage is becoming more pronounced as users of the Internet want to access their files from an increasing number of clients located in various locations, e.g. work, home, hotels, during commutes, etc.

Regardless of the type of conventional email delivery system used, the attached files from the emails are not easily organized making the files difficult to find and manage. The emails and their attached files are typically organized either by the date the email was received or by the person sending the email. Some email delivery systems allow emails and their attached files to be stored in particular folders which may be used to hold emails related to a particular subject. However, the attached files may not be separately organized and the folders provide only the most basic management capabilities. In order to organize and manage the files, users may have to transmit or copy the files attached to their emails to their client's storage area. However, transferring the files from an email system to a client takes up bandwidth across the Internet, takes time from the user during the transfer process and also consumes the client's storage area.

Some Web sites have started providing document storage managers that allow users to store and access files from a Web site storage area. The document storage managers provide functions for finding, managing and organizing the user's files in the Web site storage area. The document storage manager thus gives the users much greater control over the management of their files. Using these functions, a user from a first client may transmit a file from the first client to be stored into a Web site storage area, then move to a second client and transmit the file from the Web site storage area to the second client. This process allows the user to sequentially work on the most up to date version of the same file from a plurality of different clients by simply repeating the process of transmitting the file to the client, editing the file, and then transmitting the file back to the Web site storage area.

As discussed, Web sites that provide Web based email systems greatly increase the accessibility of emails (and their attached files) from remote clients and Web sites that provide document storage managers greatly improve the management of files that the document storage manager stored within a Web site storage area. However, Web sites that have both a Web based email system and a document storage manager are not without file management problems. A couple of these problems will be discussed with reference to FIG. 2a and FIG. 3a.

FIG. 2a illustrates a conventional process for a user to allow a document storage manager to access a file received by the user as an attachment to an email via a Web based email system. The user from a client logs onto a Web site having a Web based email system and a document storage manager. (Step 200) The user, using the Web based email system, selects an email with an attached file and (Step 201) transmits the file over the Internet to their client (Step 202). Using the document storage manager, the user may transmit the file from their client to a Web site storage area accessible by the document storage manager. (Step 203) FIG. 3a illustrates a conventional process for a user with a file stored in a Web site storage area accessible by a document storage manager to email the file to an email recipient. The user from a client logs onto a Web site having a Web based email system and a document storage manager. (Step 300) Using the document storage manager, the user transmits the file from the Web site storage area to the client. (Step 301) The user creates an email using the Web based email system (Step 302) and attaches the file that was transmitted to the client (Step 303). The user may then transmit the email with the attached file to a desired email recipient client. (Step 304)

Applicants have noticed that the described processes are more cumbersome than necessary, mainly due to a lack of communication and integration between conventional Web based email systems and conventional document storage managers. Traditional Web based email systems and document storage managers use the Client's storage area as the intermediary for transferring files between themselves. Transmitting the files over the Internet consumes Internet bandwidth and client storage area unnecessarily.

New systems and process are therefore needed to integrate the functions of a Web based email system and a document storage manager. Thus, there remains a need for systems and processes which reduce or eliminate the problems associated with the conventional methods. Specifically, systems and processes are needed to assist in accessing, transferring and organizing files received and used by Web based email systems and document storage managers.

Summary of the Invention The present invention addresses these needs by providing a Web site that includes an integrated Web based email system, document storage manager and Web site storage area, wherein the Web site storage area is accessible by both the Web based email system and the document storage manger. Specifically, integrating these components allow the Web based email system and the document storage manager to share access to files stored in the Web site storage area. In contrast, conventional Web based email systems and document storage managers require files to be routed through the client in order to share access to the files.

The Web site storage area may include any combination of hard drives, RAM or other computer memory storage devices that are known in the art. The accessibility of the Web site storage area by the Web based email system and the document storage area is very beneficial for practicing the invention, however, the specific software, firmware and hardware used to create the Web site storage area should not be used to limit the scope of the invention. The Web based email system and the document storage manager may use dedicated areas of the Web site storage area for their specific storage needs or they may share the memory storage devices of the Web site storage area. Regardless of the configuration of the memory devices used to create the Web site storage area, the Web based email system preferably has access to the files stored by the document storage manager and the document storage manager preferably has access to the files stored by the Web based email system.

The Web based email system may have the ability to transmit and receive emails and attached files with a plurality of clients located all over the world via a global computer network such as the Internet. The email system will be able to store and access those files with the Web site storage area. The Web based email system may provide other functions, as desired, such as organizing emails by date received or by the sender of the email. The Web based email system's ability to transmit, as an attached file, files stored in the Web site storage area by a document storage manager is particularly advantageous. As a result, a user may subsequently log onto the Web site from any client in the world that the user wishes to work from and transmit files stored in the Web site storage area by the document storage manager.

The document storage manager may have the ability to transmit, receive and store files with a client over a global computer network. The document storage manager will be able to store and access those files with the Web site storage area. The document storage manager may provide other functions, for example, such as managing and organizing the files stored in the Web site storage area. The document storage manager's ability to manage and organize files stored in the Web site storage area by the Web based email system is very beneficial. Thus, a user may subsequently log onto the Web site from any client in the world that the user wishes to work from and manage and organize files received as attachments to the user's email.

The integrated nature of the Web based email system and the document storage manager of the present invention allow both functions to easily share access to the same files without having to download the files to a client. Users may log onto a Web site and, while using either the Web based email system or the document storage manager, access any file associated with that user. This is in sharp contrast to prior art methods where files associated with a Web based email system could only be accessed through the Web based email system and files associated with a document storage manager could only be accessed through the document storage manager. The present invention allows a file received as an attachment to an email to be easily used by the document storage manager and a file received and managed by the document storage manager to be easily attached and transmitted as part of an email by the Web based email system.

Additional advantages and aspects of the present invention will become apparent in the following detailed description and claims.

### BRIEF DESCRIPTION OF THE DRAWINGS

FIG. 1 is a diagram illustrating the communication paths of the various components of the present invention;

FIG. 2a is a flowchart illustrating a prior art method of transferring a file received by a Web based email system to a Web site storage area accessible from a document storage manager using a client as an intermediary;

FIG. 2b is a flowchart illustrating a method according to the present invention of transferring a file received by a Web based email system to a Web site storage area accessible from a document storage manager without using a client as an intermediary;

FIG. 3a is a flowchart illustrating a prior art method of emailing a file stored in a Web site storage area accessible by a document storage manager using a client as an intermediary; and

FIG. 3b is a flowchart illustrating a method according to the present invention of emailing a file stored in a Web site storage area accessible by a document storage manager without using a client as an intermediary.

### DETAILED DESCRIPTION OF THE PREFERRED EMBODIMENTS

The present invention will now be discussed in detail with regard to the attached drawing figures which were briefly described above. In the following description, numerous specific details are set forth illustrating Applicants' best mode for practicing the invention and for enabling one of ordinary skill in the art to make and use the invention. It will be obvious, however, to one skilled in the art that the present invention may be practiced without many of these specific details. In other instances, well-known machines and process steps have not been described in particular detail in order to avoid unnecessarily obscuring the present invention. Unless otherwise indicated, like parts and processes are referred to with like reference numerals.

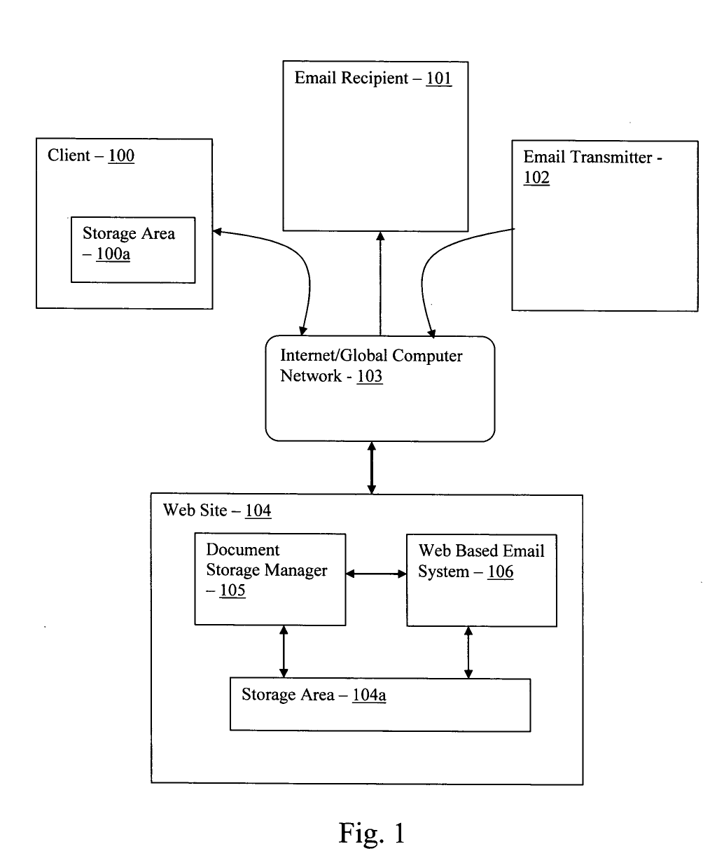

The invention will now be described in greater detail with continuing reference to FIG. 1. A Web site 104 is provided that is accessible by a plurality of clients 100 over a global computer network such as the Internet 103. The Internet permits the Web site 104 to be accessed from a large number of different locations, such as from their work, home, hotel, etc.

Users of the Internet may use clients 100, typically personal computers with a relatively small storage area 100a, to access the Web site 104. FIG. 1 illustrates three clients (labeled Client—100, Email Recipient—101, and Email Transmitter—102), but in reality hundreds of millions of clients 100 are connected to the Internet 103. A particular user may want to maintain access to their files, e.g. documents, and emails, as the user moves from client to client.

If a user's files and emails were stored in a storage area 100a on a particular client 100, the user would lose access to those files and emails when the user moved to another client. The solution is to have a Web site storage area 104a that may be accessible from a large number of clients 100 and that may be used to store the files and emails of the user. This allows the user to access their files and emails from any client that has access to the Internet 103 with the added benefit of not wasting the storage area 100a on their client 100.

In addition to accessibility, users want their files and emails to be secure, i.e. only the user or persons authorized by the user may have access to view or alter the files and emails. The Web site 104 may require users to log onto the Web site 104, for example, by entering an account name and password, before receiving access to the user's files and emails. Once logged on, the user may give other users access to particular files and emails stored in the Web site storage area 104a. The other users may then perform actions on the emails and files in the manner authorized by the user.

The Web site 104 may offer users the capabilities of a Web based email system that allows users to transmit emails to email recipients 101. The users may attach one or more files to the emails that are transmitted to the email recipients 101. The user may also receive emails with one or more attached files from email transmitters 102. The user may store the received emails and files in the Web site storage area 104a, thereby making the files and email subsequently available to the Web based email system 106 or the document storage manager 105.

The Web site 104 may also offer users the capabilities of a document storage manager that allows users to easily organize and manage files stored in a Web site storage area 104a. The user may copy files in a client storage area 100a to the Web site storage area 104. This allows the user to then access the files from any client 100 that the user wishes to use and also allows the user to save and organize the files with other files the user already has. The user may copy files in the Web site storage area 104a to a client storage area 100a. This allows the user to then run desired applications at the client 100 to edit, archive or perform other functions on the files.

It should be noted that the invention allows the files stored in the Web site storage area 104a to be accessed by both the Web based email system 106 and the document storage manager 105, regardless of how the files were stored in the storage area 104a. This provides the users with much greater flexibility in managing their files than with prior art systems. The user may have access to all their files from either option.

It should also be noted that the Web based email system 106 and document storage manager 105 may appear as two separate options or may appear as a single option on the Web site 104. If separate options are provided to the user, the user may select either the Web based email system 106 or the document storage manager 105 and be given access to the features of the selected option, but have the additional ability to access files stored in the Web based storage area 104a by the non-selected option.

If a single integrated option is provided to the user on the Web site 104, the user may select the integrated option and be given access to the features and functions of both the Web based email system and the document storage manager. Thus, the Web based email system 106 and the document storage manager 105 may be, or appear, as one seamless program to the user whereby the user has all the functions of both options available to the user at the same time.

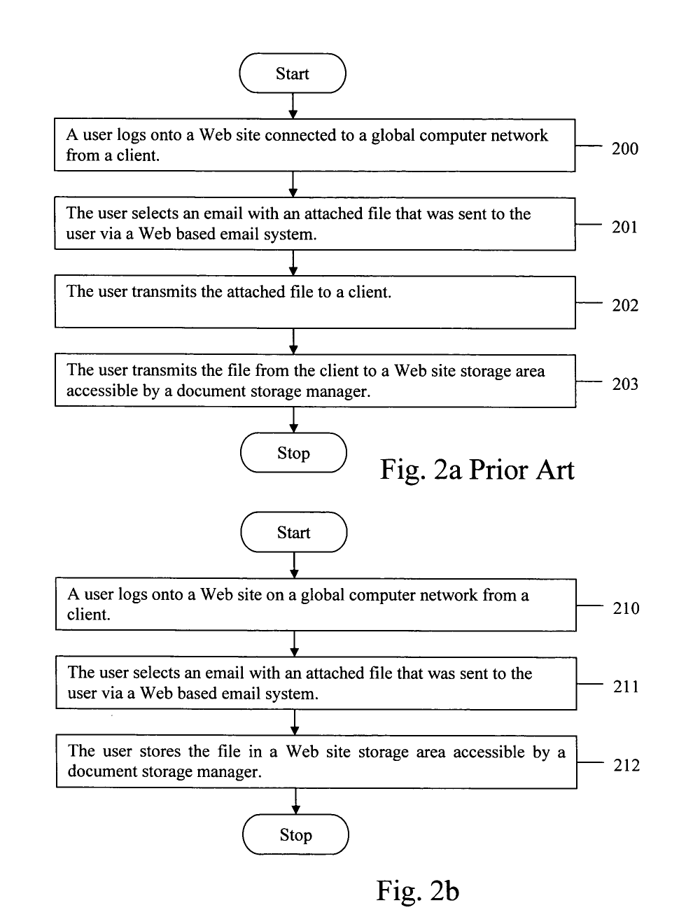

An exemplary process of practicing the invention will now be discussed with reference to FIG. 2b. A user may log onto a Web site 104 from a remote client 100 via the Internet 103. (Step 210) Typically, the user will be authenticated by the Web site 104, for example by requiring entry of a password, to make sure the user is authorized to access particular emails and files stored in the Web site storage area 104a. The Web site may include functions associated with a Web based email system 106 and a document storage manager 105 and may include other desired functions. The user, using the functions of the Web based email system 106, may select an email with an attached file that was sent to the user from an email transmitter 102. (Step 211) The user may store the attached file in a Web site storage area 104a or the Web based email system 106 may automatically store the attached file in the Web site storage area 104a. (Step 212) Once the file has been stored in the Web site storage area 104a using the Web based email system, the file may be subsequently accessed by either the Web based email system 106 or the document storage manager 105.

For example the user may subsequently log onto the Web site 104 from the same or a second client 100. The user may then create an email, select an email recipient 101, select and attach the file stored in the Web site storage area 104a and transmit the email and attached file to the selected recipient 101 using the Web based email system 106.

Another process the user may subsequently perform is to log onto the Web site 104 from the same or a second client 100 and, using the document storage manager, transmit the file from the Web site storage area 104a to the client storage area 100a. This allows software on the client 100 to directly perform desired functions, such as editing or archiving, on the file at the client.

The user may also authorize other users, for example a second user, to access one or more of the user's files stored in the Web site storage area 104a. The second user may then, for example, transmit the files as attachments to emails or transmit the files to their client using the document storage manager.

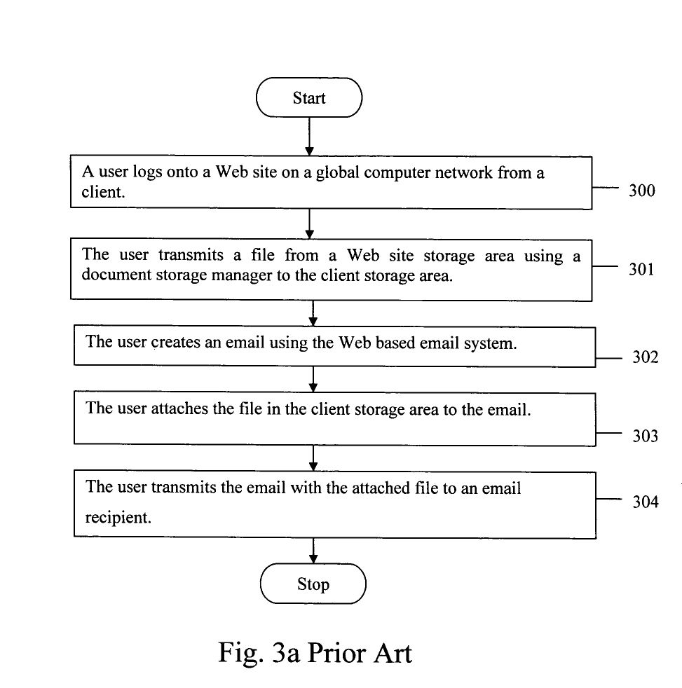

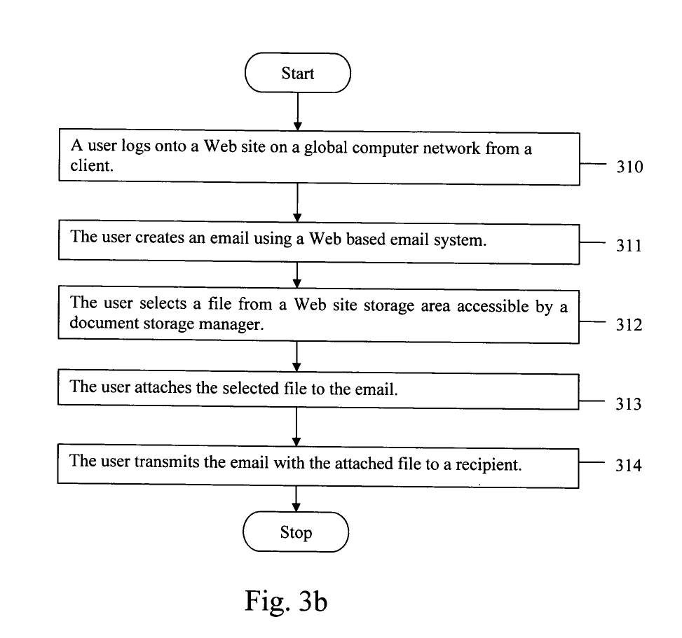

Another exemplary process for practicing the present invention will be discussed with reference to FIG. 3b. A user may log onto a Web site 104 from a client 100 via the Internet 103. (Step 310) One or more files belonging to the user may have already been stored in the Web site storage area 104a by either the Web based email system 106 or by the document storage manager 105 during previous visits to the Web site 104. The user may create an email (step 311), select one or more files stored in the Web site storage area 104a (step 312), attach the file(s) to the email (step 313), and transmit the email and attached file(s) to an email recipient 101 (step 314). This process allows users to easily email files as attachments that where loaded, managed and controlled by a document storage manager 105.

In view of the foregoing, it will be understood by those skilled in the art that the systems and processes of the present invention can facilitate the control and management of files used by a Web based email system 106 and a document storage manager 105. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Such variations and modifications, however, fall well within the scope of the present invention as set forth in the following claims.

1. A Web site that allows a user from a client to transmit and receive emails and organize files, comprising:
A) a Web site storage area for storing emails and files;
B) a Web based email system having the ability to transmit and receive emails and attached files between a plurality of clients connected to a global computer network and the ability to store and access emails and files with the storage area; and
C) a document storage manager having the ability to transmit and receive files between a client and the ability to store and access files with the storage area, wherein, without transmitting the files to a client, the Web based email system has the ability to access files stored in the storage area by the document storage manager.

2. The Web site of claim 1, wherein the Web based email system and the document storage manager appear as a single seamless option on the Web site to the user.

3. The Web site of claim 1, wherein the Web based email system and the document storage manager appear as separate options on the Web site to the user.

4. A Web site that allows a user from a client to transmit and receive emails and organize files, comprising:
A) a Web site storage area for storing emails and files;
B) a Web based email system having the ability to transmit and receive emails and attached files between a plurality of clients connected to a global computer network and the ability to store and access emails and files with the storage area; and
C) a document storage manager having the ability to transmit and receive files between a client and the ability to store and access files with the storage area, wherein, without transmitting the files to a client, the document storage manager has the ability to access files stored in the storage area by the Web based email system.

5. The Web site of claim 4, wherein the Web based email system and the document storage manager appear as a single seamless option on the Web site to the user.

6. The Web site of claim 4, wherein the Web based email system and the document storage manager appear as separate options on the Web site to the user.

7. A Web site that allows a user from a client to transmit and receive emails and organize files, comprising:
A) a Web site storage area for storing emails and files;
B) a Web based email system having the ability to transmit and receive emails and attached files between a plurality of clients connected to a global computer network and the ability to store and access emails and files with the storage area; and
C) a document storage manager having the ability to transmit and receive files between a client and the ability to store and access files with the storage area, wherein, without transmitting the files to a client, the Web based email system has the ability to access files stored in the storage area by the document storage manager and the document storage manager has the ability to access files stored in the storage area by the Web based email system.

8. The Web site of claim 7, wherein the Web based email system and the document storage manager appear as a single seamless option on the Web site to the user.

9. The Web site of claim 7, wherein the Web based email system and the document storage manager appear as separate options on the Web site to the user.

10. A process for a user to manage files at a Web site using an integrated document storage manager and a Web based email system, comprising the steps of:
A) a user logging onto a Web site on a global computer network from a client, wherein the Web site includes an integrated document storage manager and a Web based email system;
B) the user selecting an email with an attached file that was delivered to the user via the Web based email system;
C) storing the file in the Web site storage area; and
D) the user accessing the attached email file with the document storage manager, wherein the file was not transmitted to the client.

11. The process of claim 10, further comprising the steps of:
E) the user logging onto the Web site for a second time from a client;
F) the user creating an email using the Web based email system;
G) the user selecting a recipient to receive the email;
H) the user selecting the file from the Web site storage area;
I) the user attaching the selected file to the email; and
J) the user transmitting the email with the attached file to the selected recipient.

12. The process of claim 10, further comprising the steps of:
E) the user logging onto the Web site for a second time from the client;
F) the user selecting the file from the Web site storage area using the document storage manager; and
G) the user transmitting the file to the client.

13. The process of claim 10, further comprising the steps of:
E) the user logging onto the Web site for a second time from a second client;
F) the user selecting the file from the Web site storage area using the document storage manager; and
G) the user transmitting the file to the second client.

14. The process of claim 10, further comprising the step of:
E) the user authorizing a second user to have access to the file stored in the Web site storage area.

15. The process of claim 14, further comprising the steps of:
F) the second user logging onto the Web site for a client;
G) the second user creating a second email using the Web based email system;
H) the second user selecting a second recipient to receive the second email;
I) the second user selecting the file from the Web site storage area;
J) the second user attaching the selected file to the second email; and
K) the Web based email system transmitting the second email with the attached file to the second selected recipient.

16. The process of claim 14, further comprising the steps of:
F) the second user logging onto the Web site from a client;
G) the second user selecting the file from the Web site storage area using the document storage manager; and
H) the second user transmitting the file to the client.

17. The process of claim 14, wherein the Web based email system and the document storage manager appear as a single option on the Web site and once selected the functions of both are made available to the user.

18. The process of claim 14, wherein the Web based email system and the document storage manager appear as separate options on the Web site and once selected the functions of the selected option are made available to the user.

19. A process for a user to manage files at a Web site using an integrated document storage manager and a Web based email system, comprising the steps of:
A) a user creating a file on a client;
B) the user logging onto a Web site on a global computer network from the client;
C) the user storing the file in a Web site storage area using a document storage manager;
D) the user creating an email using a Web based email system;
E) the user selecting a recipient;
F) the user selecting the file from the Web site storage area to attach to the email; and
G) the user transmitting the email with the attached file to the selected recipient.

20. The process of claim 19, further comprising the step of prior to transmitting the email with the attached file to the recipient, compressing the attached file to reduce the bandwidth necessary to transmit the file.

21. The process of claim 19, wherein the Web based email system and the document storage manager appear as a single option on the Web site and once selected the functions of both are made available to the user.

22. The process of claim 19, wherein the Web based email system and the document storage manager appear as separate options on the Web site and once selected the functions of the selected option are made available to the user.
